(19) United States
(12) Patent Application Publication
(10) Pub. No.: US 2013/0060960 A1
(43) Pub. Date: Mar. 7, 2013

(54) OPTIMIZING SOFTWARE APPLICATIONS IN A NETWORK

(71) Applicants: Miguel SANG, Austin, TX (US); David W. Bachmann, Leander, TX (US); Randolph M. Forlenza, Austin, TX (US)

(72) Inventors: Miguel SANG, Austin, TX (US); David W. Bachmann, Leander, TX (US); Randolph M. Forlenza, Austin, TX (US)

(73) Assignee: International Business Machines Corporation, Armonk, NY (US)

(21) Appl. No.: 13/223,537

(22) Filed: Sep. 1, 2011

(51) Int. Cl. G06F 15/16

(52) U.S. Cl. 709/233

(57) ABSTRACT

A method, system and computer program product include determining a dynamic target latency time for sending packets over a network, where the dynamic target latency time is based on at least one policy and delaying packets that are smaller than a maximum transmission unit (MTU) from being sent over the network until the dynamic target latency time has elapsed.

### BACKGROUND

Software applications running on networks such as the Internet send data between servers and destination nodes such as mobile devices. Examples of such software applications include mobile applications and cloud-based applications, which typically send data in packets. Network congestion and latency are factors that affect the responsiveness of software applications running on a network.

### BRIEF SUMMARY

According to one embodiment, a method includes determining a dynamic target latency time for sending packets over a network, where the dynamic target latency time is based on at least one policy. The method also includes delaying packets that are smaller than a maximum transmission unit (MTU) from being sent over the network until the dynamic target latency time has elapsed.

System and computer program products corresponding to the above-summarized method are also described and claimed herein.

### BRIEF DESCRIPTION OF THE DRAWINGS

FIG. 1 is a simplified block diagram of an example environment for optimizing software applications in a network, according to one embodiment.

FIG. 2 is a simplified block diagram of an example hardware implementation of a computer system/server, according to one embodiment.

FIG. 3 is a simplified flowchart illustration of an example method, according to one embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, another programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Embodiments optimize applications running on networks by dynamically delaying the sending of packets over a network such as the Internet using dynamic target latency times. In one embodiment, a method includes a system determining a maximum transmission unit (MTU) for a communications protocol for a network and determining a target latency time for sending packets over the network. In one embodiment, the dynamic target latency time is based on one or more policies that accommodate varying circumstances and data requirements. Such dynamic latency times improve response times of applications such as mobile applications and cloud applications.

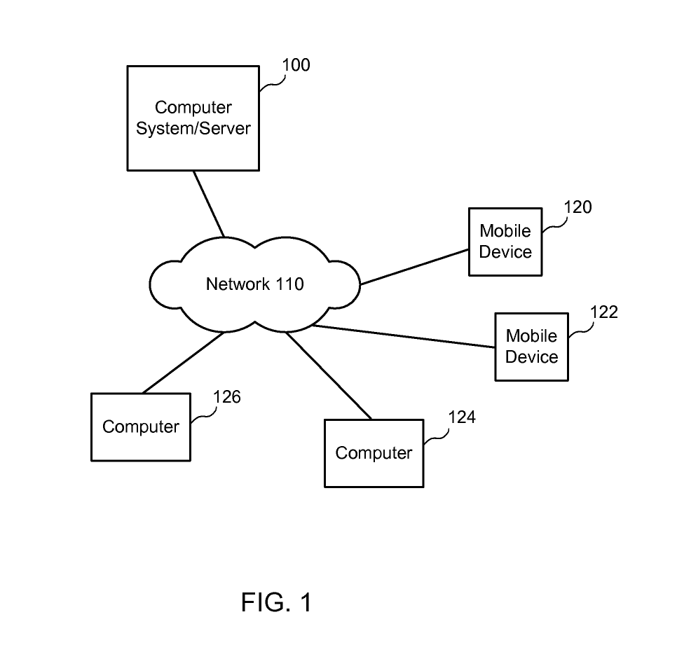

FIG. 1 is a simplified block diagram of an example environment for optimizing software applications in a network, according to one embodiment. FIG. 1 shows a computer system/server 100, a network 110, and user nodes 120, 122, 124, and 126. User nodes 120-126 may be local computing devices used by users such as cloud consumers. For example, user nodes 120 and 122 (labeled “mobile devices”) may each represent one or more personal digital assistants (PDAs), cellular telephones, etc. User nodes 124 and 126 (labeled “computers”) may each represent one or more desktop computers, laptop/notebook computers, automobile computer systems, etc. User nodes 120-126 may communicate with one another or with computer system/server 100 via network 110. User nodes may be grouped (not shown) physically or virtually, in one or more networks, such as private, community, public, or hybrid clouds, or a combination thereof. This allows for environments such as cloud computing environments to offer infrastructure, platforms and/or software as services. It is understood that the types of computing devices shown in FIG. 1 are intended to be illustrative only, and that computing nodes 120-126 can communicate with any type of computerized device over any type of network and/or network addressable connection (e.g., using a web browser).

In one embodiment computer system/server 100 may transmit data and other information to user nodes 120-126 over network 110 using any suitable network protocol such as Transmission Control Protocol/Internet Protocol (TCP/IP). Such data may be provided by any application running on network 110. Such an application may include mobile applications, cloud-based applications, etc., and may reside in computer system/server 100 or at any other suitable location.

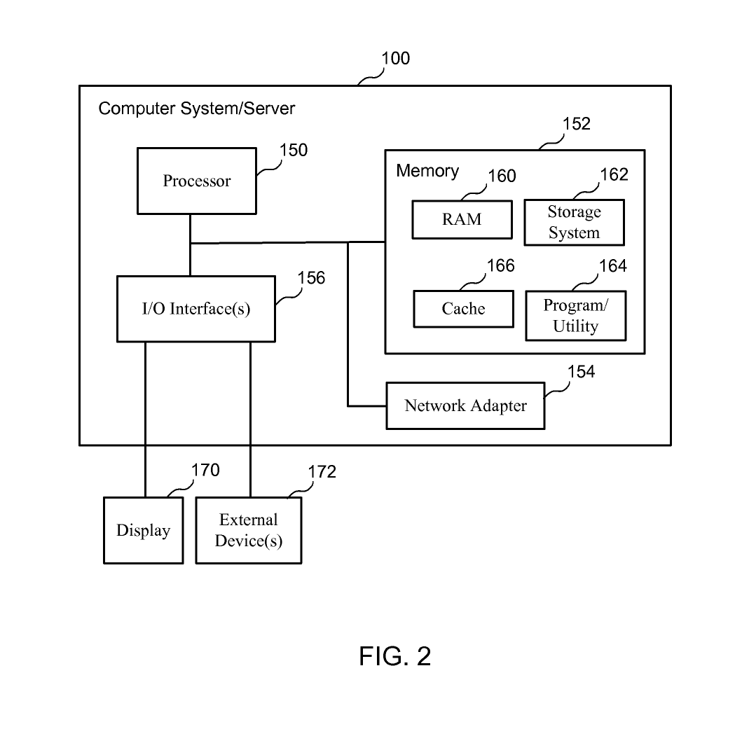

FIG. 2 is a simplified block diagram of an example hardware implementation of computer system/server 100 shown in FIG. 1, according to one embodiment. Computer system/server 100 includes a processor 150, a memory 152, a network adapter 154, and an input/output (I/O) interface 156. In one embodiment, memory 152 may include a RAM 160, a storage system 162, a program/utility 164, and a cache memory 166. In one embodiment, computer system/server 100 is operationally coupled to processor 150 and a computer readable medium such as memory 152 or any sub-component thereof. The computer readable medium stores computer readable program code for implementing methods of embodiments described herein. The processor executes the program code according to the various embodiments of the present invention.

As shown in FIG. 2, computer system/server 100 is shown in the form of a general-purpose computing device. The components of computer system/server 100 may include, but are not limited to, the components 150-154 shown. Computer system/server 100 may connect and communicate with a display 170 and any other external devices 172.

The components 150-154 may be connected by one or more of any of several types of bus structures, including a memory bus or memory controller, a peripheral bus, an accelerated graphics port, and a processor or local bus using any of a variety of bus architectures. By way of example, and not limitation, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus.

Computer system/server 100 typically includes a variety of computer system readable media. Such media may be any available media that is accessible by computer system/server 100; and it may include both volatile and non-volatile media, as well as removable and non-removable media.

Memory 152 may include computer system readable media in the form of volatile memory, such as RAM 160 and/or cache memory 166. Computer system/server 100 may further include other removable/non-removable, volatile/non-volatile computer system storage media. By way of example only, storage system 162 can be provided for reading from and writing to a non-removable, non-volatile magnetic media (not shown and typically called a “hard drive”). Although not shown, other features may be provided, such as a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media. In such instances, each can be connected to a bus by one or more data media interfaces. As will be further depicted and described below, memory 152 may include at least one program product having a set (e.g., at least one) of program modules that are configured to carry out the functions of the embodiments.

Program/utility 164, having a set (at least one) of program modules (not shown), may be stored in memory 152 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

As indicated above, computer system/server 100 may also communicate with: one or more external devices 172 such as a keyboard, a pointing device, a display 170, etc.; one or more devices that enable a user to interact with computer system/server 100; and/or any devices (e.g., network card, modem, etc.) that enable computer system/server 100 to communicate with one or more other computing devices. Such communication can occur via I/O interfaces 156. Still yet, computer system/server 100 can communicate with one or more networks such as a local area network (LAN), a general wide area network (WAN), and/or a public network (e.g., the Internet) via network adapter 154. As depicted, network adapter 154 communicates with the other components of computer system/server 100 via any suitable bus. It should be understood that although not shown, other hardware and/or software components could be used in conjunction with computer system/server 100. Examples, include, but are not limited to: microcode, device drivers, redundant processing units, external disk drive arrays, RAID systems, tape drives, and data archival storage systems, etc.

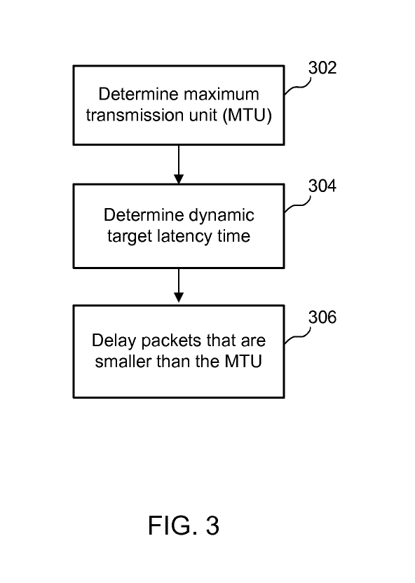

FIG. 3 is a simplified flowchart illustration of an example method of operation of the system of FIG. 1, according to one embodiment. As described in more detail below, in one embodiment, the method optimizes software applications in a network by regulating latency in packet transmissions for the network. Referring to both FIGS. 1 and 3, the process begins in block 302, where system 100 determines a maximum transmission unit (MTU) for a communications protocol for a network such as network 110. In one embodiment, the MTU is the maximum size or length of a given packet that is transmitted without dividing the packet into multiple packets. The MTU may vary depending on the particular network protocol being used.

In block 304, system 100 determines a dynamic target latency time for sending packets over the network. In one embodiment, the dynamic target latency time is an amount of time that system 100 takes in delaying the sending of the packet over the network if the packet is not yet full. In one embodiment, the dynamic target latency time may be enforced regardless of the amount of data to be sent.

In one embodiment, the dynamic target latency time may be based on at least one policy. In various embodiments, computer system/server 100 may determine the dynamic target latency time using any one or more policies described herein. These policies adapt to and accommodate different scenarios and data requirements of various network protocols. In one embodiment, an external entity (e.g., an external server, etc.) may determine and/or manage the dynamic latency time.

In one embodiment, computer system/server 100 may apply a policy, where computer system/server 100 determines the dynamic target latency time using a fixed or variable value. For example, in one embodiment, computer system/server 100 may determine one or more values, which may be fixed or variable, and then compute the dynamic target latency time using the determined value. Computer system/service 100 may derive the dynamic target latency time from a fixed value, a current latency time, or other variable value.

In one embodiment, computer system/server 100 may apply a policy, where computer system/server 100 determines the dynamic target latency time using a percentage of a current latency time. For example, in one embodiment, computer system/service 100 may determine a current latency time and then compute a percentage of the current latency time to determine the dynamic target latency time.

In one embodiment, computer system/server 100 may apply a policy, where computer system/server 100 determines the dynamic target latency time using an average latency time. For example, in one embodiment, computer system/server 100 may measure actual latency times observed when computer system/server 100 transmits packets across the network. Computer system/server 100 may then compute an average latency time from the measured latency times. In one embodiment, computer system/server 100 may determine latency times for averaging using various methods. For example, in one embodiment, computer system/server 100 may determine existing acknowledgement response times that a TCP implementation already measures and uses to set retransmission timeouts. In another example, computer system/server 100 may measure latency periodically by sending out a “ping” (e.g., Internet Control Message Protocol (ICMP) echo request, also know as ICMP Type 8) to the other end of the connection (e.g., to a recipient user node). Computer system/server 100 may then compute an average latency time from the measured response times of the acknowledgements and/or pings. In one embodiment, computer system/server 100 may specify a minimum or maximum dynamic target latency time based on a TCP/IP parameter or on any arbitrary value.

In one embodiment, computer system/server 100 may compute the dynamic target latency time using variables provided by a variety of sources such as a TCP/IP parameter in window registry, the application providing the data to be sent, an adaptive algorithm in computer system/server 100, or other suitable system that observes and measures response times, etc.

In one embodiment, computer system/server 100 may apply a policy, where computer system/server 100 determines the dynamic target latency time using one or more tiered services. For example, computer system/server 100 may determine different levels of service tiers and assign higher-level service tiers with corresponding shorter dynamic target latency time. Conversely, computer system/server 100 may assign lower-level service tiers with corresponding longer dynamic target latency times. In other words, in one embodiment, the dynamic target latency times may be inversely proportional to the levels of service tiers. As a result, the user node of a user subscribing to a higher-level service tier would receive packets faster than a user node of a user subscribing to a lower-level service tier. In one embodiment, the dynamic target latency time may be based on one or more service levels. In one embodiment, a service tier may or may not include performance metrics (e.g., latency, time availability of the service, etc.). In one embodiment, a service level includes performance metrics.

Referring still to FIG. 3, in block 306, system 100 delays packets that are smaller than the MTU from being sent over network 110 until the dynamic target latency time has elapsed. For example, in one embodiment, when system 100 receives data to be sent over the network, the latency time begins to elapse. System 100 may receive the data from any source such as an application or another sender system, etc. Note that the terms application and software application are used interchangeably. System 100 compares the size of the packet to the MTU. If the packet size is less than the MTU, the latency time continues to elapse until the dynamic target latency time is reached. If the packet size is still smaller than the MTU when the dynamic target latency time has elapsed, system 100 sends the packet to the destination node(s) (e.g., user nodes 120-126, etc.) even if the packet is not yet full. In one embodiment, if the packet becomes full before the dynamic target latency time is reached, system 100 sends the packet to the destination node(s) when the packet becomes full. In one embodiment, system 100 may delay packets until previous packets have been acknowledged by the receiver. As such, embodiments described herein enable more frequent, smaller packets to be sent over the network, as opposed to sending larger packets using fixed latency times. Fixed latency times may cause unnecessary delays in data transmission, which the embodiments described herein avoid. Embodiments described herein minimize issues with network congestion and latency, which can slow down application responsiveness.

Embodiments described herein have several significant impacts on various applications using network protocol implementations. For example, embodiments reduce network congestion while simultaneously providing a mechanism that dynamically balances the impact on packet latency. Some applications, such as mobile online banking applications, running on mobile devices require secure communications. Such secure communications may utilize a secure sockets layer (SSL), which involves SSL handshakes using small packet requests. SSL handshakes can also occur when a mobile device is moving between cell towers, when a mobile device establishes new SSL connections, or when a mobile device switches between multiple applications that require SSL handshakes. These small packet requests require the transmission of many small packets over the network. Embodiments reduce the impact of latency times on such SSL handshakes on the mobile application response times by utilizing dynamic latency times.

Embodiments also reduce network resource requirements by reducing bandwidth utilization, reducing packet processing requirements, etc. Embodiments also increase the number of applications that can use the same network resources. Embodiments are also applicable to cloud-based applications, where a browser may run code that makes many small requests, new connections, and/or new handshakes. Cloud application providers may use embodiments described herein to throttle the response time of applications, and as well as to enable tiered services.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining a dynamic target latency time for sending packets over a network, wherein the dynamic target latency time is based on at least one policy; and
delaying packets that are smaller than a maximum transmission unit (MTU) from being sent over the network until the dynamic target latency time has elapsed.

2. The method of claim 1, wherein the determining the dynamic target latency time for sending the packets over the network comprises:
providing the dynamic target latency time for sending the packets over the network by an adaptive algorithm.

3. The method of claim 1, wherein the determining the dynamic target latency time for sending the packets over the network comprises:
assigning the dynamic target latency time to a service tier.

4. The method of claim 1, wherein the determining the dynamic target latency time for sending the packets over the network comprises:
assigning a first dynamic target latency time to a first service tier;
assigning a second dynamic target latency time to a second service tier, wherein the first service tier is higher than the second service tier, wherein the first dynamic target latency time is shorter than the second dynamic target latency time; and
selecting one of the first and second dynamic target latency times corresponding to the respective first or second service tier that is associated with the packets.

5. The method of claim 1, wherein the determining the dynamic target latency time for sending the packets over the network comprises:
determining a plurality of latency times; and
computing an average of the latency times.

6. The method of claim 1, wherein the determining the dynamic target latency time for sending the packets over the network comprises:
determining a current latency time; and
computing a percentage of the current latency time.

7. The method of claim 1, the determining the dynamic target latency time for sending the packets over the network comprises:
receiving the dynamic target latency time from an application providing the data to be sent.

8. A computer program product for optimizing software applications in a network, the computer program product comprising:
a computer readable storage medium having computer readable program code embodied therewith, the computer readable program code configured to:
determine a dynamic target latency time for sending packets over a network, wherein the dynamic target latency time is based on at least one policy; and
delay packets that are smaller than a maximum transmission unit (MTU) from being sent over the network until the dynamic target latency time has elapsed.

9. The computer program code of claim 8,
wherein when determining the dynamic target latency time for sending the packets over the network, the computer readable program code is configured to:
provide the dynamic target latency time for sending the packets over the network by an adaptive algorithm.

10. The computer program code of claim 8, wherein when determining the dynamic target latency time for sending the packets over the network, the computer readable program code is configured to:
assign the dynamic target latency time to a service tier.

11. The computer program code of claim 8, wherein when determining the dynamic target latency time for sending the packets over the network, the computer readable program code is configured to:
assign a first dynamic target latency time to a first service tier;
assign a second dynamic target latency time to a second service tier, wherein the first service tier is higher than the second service tier, wherein the first dynamic target latency time is shorter than the second dynamic target latency time; and
select one of the first and second dynamic target latency times corresponding to the respective first or second service tier that is associated with the packets.

12. The computer program code of claim 8, wherein when determining the dynamic target latency time for sending the packets over the network, the computer readable program code is configured to:
determine a plurality of latency times; and
compute an average of the latency times.

13. The computer program code of claim 8, wherein when determining the dynamic target latency time for sending the packets over the network, the computer readable program code is configured to:
determine a current latency time; and
compute a percentage of the current latency time.

14. The computer program code of claim 8, wherein when determining the dynamic target latency time for sending the packets over the network, the computer readable program code is configured to:
receive the dynamic target latency time from an application providing the data to be sent.

15. A system comprising:
a processor; and
a computer readable storage medium having computer readable program code embodied therewith, the computer readable program code which when executed by the processor executes a method comprising:
determining a dynamic target latency time for sending packets over a network, wherein the dynamic target latency time is based on at least one policy; and
delaying packets that are smaller than a maximum transmission unit (MTU) from being sent over the network until the dynamic target latency time has elapsed.

16. The system of claim 15,
wherein the determining the dynamic target latency time for sending the packets over the network comprises:
providing the dynamic target latency time for sending the packets over the network by an adaptive algorithm.

17. The system of claim 15, wherein the determining the dynamic target latency time for sending the packets over the network comprises:
assigning the dynamic target latency time to a service tier.

18. The system of claim 15, wherein the determining the dynamic target latency time for sending the packets over the network comprises:
assigning a first dynamic target latency time to a first service tier;
assigning a second dynamic target latency time to a second service tier, wherein the first service tier is higher than the second service tier, wherein the first dynamic target latency time is shorter than the second dynamic target latency time; and
selecting one of the first and second dynamic target latency times corresponding to the respective first or second service tier that is associated with the packets.

19. The system of claim 15, wherein the determining the dynamic target latency time for sending the packets over the network comprises:
determining a plurality of latency times; and
computing an average of the latency times.

20. The system of claim 15, wherein the determining the dynamic target latency time for sending the packets over the network comprises:
determining a current latency time; and
computing a percentage of the current latency time.

21. The system of claim 15, the determining the dynamic target latency time for sending the packets over the network comprises:
receiving the dynamic target latency time from an application providing the data to be sent.

22. A method comprising:
determining a dynamic target latency time for sending packets over a network, comprising:
determining one or more values; and
computing the dynamic target latency time using the determined value; and
delaying packets that are smaller than a maximum transmission unit (MTU) from being sent over the network until the dynamic target latency time has elapsed.

23. The method of claim 22, wherein the one or more values include one or more measured latency times.

24. The method of claim 22, wherein the one or more values include one or more measured latency times, and wherein the computing the dynamic target latency time using the determined value comprises:
computing a percentage of the one or more measured latency times.

25. The method of claim 22, wherein the one or more values include one or more measured latency times, and wherein the computing the dynamic target latency time using the determined value comprises:
computing an average of the one or more measured latency times.
